(19) United States
(12) Patent Application Publication
(10) Pub. No.: US 2010/0248715 A1
(43) Pub. Date: Sep. 30, 2010

(54) SYSTEMS AND METHOD FOR OPTIMIZING WIRELESS LOCAL AREA NETWORK CHANNEL SCANNING

(76) Inventors: Soren Lundsgaard, Inverness, IL (US); Puneet Batta, San Jose, CA (US)

Correspondence Address: MOTOROLA, INC., 1303 EAST ALGONQUIN ROAD, IL01/3RD, SCHAUMBURG, IL, 60196, US

(21) Appl. No.: 12/628,500

(22) Filed: Dec. 1, 2009

Related U.S. Application Data
(60) Provisional application No. 61/165,158, filed on Mar. 31, 2009.

(51) Int. Cl. H04W 92/02; H04W 72/04

(52) U.S. Cl. 455/432.1; 370/338; 455/434

(57) ABSTRACT

The present disclosure optimizes wireless local area network (WLAN) channel scanning by collecting roaming data and passing summary information to wireless clients. The wireless clients are configured to utilize the summary information for WLAN channel scanning, roaming, etc. The present invention further includes a scanning algorithm associated with wireless clients that is weighted to scan more likely channels. Also, the present invention may weight the scanning algorithm to avoid radar avoidance channels, such as in IEEE 802.11h. Further, the scanning algorithm may be weighted to scan more often of channels with fast rates of change in wireless signal strength and the like. Advantageous, the present invention utilizes real data to optimize channel scanning at wireless clients thereby improving battery life and user experience while roaming.

### CROSS-REFERENCE TO RELATED APPLICATION(S)

The present non-provisional patent application claims priority to U.S. Provisional Patent Application Ser. No. 61/165,158, filed Mar. 31, 2009 and entitled “WNMP CHANNEL INFORMATION MESSAGE TO OPTIMIZE CHANNEL SCANNING AND 802.11h,” which is incorporated in full by reference herein.

### FIELD OF THE INVENTION

The present invention relates generally to wireless local area networks (WLANs), and more particularly to systems and methods for optimizing WLAN channel scanning and IEEE 802.11h through channel information messages such as through the Wireless Network Management Protocol (WNMP) and the like.

### BACKGROUND OF THE INVENTION

Typically, a Wireless Local Area Network (WLAN) mobile subscriber unit scans all channels to determine whether an access point (AP) is available. Disadvantageously, this can consume battery power on the mobile unit due to unused or unusable channels within a facility in addition to increasing connection time. Furthermore, using IEEE 802.11h controlled channels presents a problem in that active probing is not allowed, increasing the amount of time needed to scan the channels. For example, in the IEEE 802.11h 5 GHz band, some channels are subject to radar avoidance (RA). As such, access points (APs) are responsible for detecting radar (e.g., receiver is on except when transmitting). When an AP detects radar, the AP informs associated STAs (stations, i.e. mobile subscriber units) that the channel is no longer valid. The STAs must then move off the channel within approximately 10 seconds. As such, there is a need to listen before transmitting but it can be expensive to do scans on IEEE 802.11h RA channels. For example, in some implementations, scans are performed on channels that are not even in use. Accordingly, there is a need for improved methods, systems, and apparatus for addressing these issues.

### BRIEF SUMMARY OF THE INVENTION

In an exemplary embodiment, a wireless network includes an access device; and one or more clients each communicatively coupled to the access device; wherein the access device is configured to transmit roaming event data associated with each roaming event for the one or more clients. The wireless network can further include a wireless switch; and a plurality of access devices each communicatively coupled to the wireless switch. The one or more clients are configured to periodically scan wireless channels to detect any of the plurality of access devices on the wireless channels. The one or more clients are configured to request channel information from one of the wireless switch or the plurality of access devices, and wherein the one or more clients are configured to adapt a scanning pattern based on the channel information. Optionally, the scanning pattern is adapted to scan more often the wireless channels with recent roaming events instead of the wireless channels with less recent roaming events. Alternatively, the scanning pattern is adapted to scan more often the wireless channels with higher rates of change in wireless signal strength instead of the wireless channels with lower rates of change in wireless signal strength. Further, the scanning pattern is adapted to scan less often the wireless channels determined to be radar avoidance channels instead of the wireless channels not determined to be radar avoidance channels. Each roaming event can be stored as a tuple of information including (identification of one of the plurality of access devices roamed from, a channel of another one of the plurality of access devices roamed from, a timestamp of the roaming event). The one or more clients are configured to periodically scan wireless channels to detect any of the plurality of access devices on the wireless channels, wherein the one or more clients are configured to request channel information from one of the wireless switch or the plurality of access devices, wherein the channel information including a plurality of tuples with each of the identification of one of the plurality of access devices roamed from element including a current access device that the one or more clients is connected to, and wherein the one or more clients are configured to adapt a scanning pattern based on the plurality of tuples. The tuple further includes an identification of wireless signal strength, and wherein the scanning pattern is adapted to scan channels with high rates of change of the wireless signal strength relative to channels with low rates of change of the wireless signal strength. The channel information can be transmitted to the one or more clients by one of the wireless switch or the plurality of access devices through an IEEE 802.11 vendor specific frame format. Optionally, one of the plurality of access devices operates according to IEEE 802.11h, wherein the one of the plurality of access devices is configured to detect radar avoidance channels amongst the wireless channels, and the one or more clients are configured to adapt a scanning pattern based on the detection of radar avoidance channels thereby eliminating or reducing unnecessary IEEE 802.11h channel scanning.

In another exemplary embodiment, a method of scanning channels in a wireless network includes, at one of a switch or an access device, monitoring for roaming events associated with a plurality of access devices communicatively coupled to one or more clients; recording data associated with each of the roaming events; and responsive to a request from a client, summarizing the recorded data and transmitting the summarized recorded data to the client. The method further includes, at the client, receiving the summarized recorded data; and adapting a scanning pattern of a plurality of wireless channels in the wireless network based on the summarized recorded data. Optionally, the scanning pattern is adapted to scan more often the plurality of wireless channels with recent roaming events instead of the plurality of wireless channels with less recent roaming events. Alternatively, the scanning pattern is adapted to scan more often the plurality of wireless channels with higher rates of change in wireless signal strength instead of the plurality of wireless channels with lower rates of change in wireless signal strength. Further, the scanning pattern is adapted to scan less often the plurality of wireless channels determined to be radar avoidance channels instead of the plurality of wireless channels not determined to be radar avoidance channels.

In yet another exemplary embodiment, a wireless client includes a radio, memory, and a processor, wherein each of the radio, the memory, and the processor are communicatively coupled to one another; wherein the radio, the memory, and the processor are configured to: periodically scan a plurality of wireless channels in a wireless network; request channel information from one of an access point or a wireless switch; and adapt a scanning pattern of the plurality wireless channels based on the channel information. Optionally, the scanning pattern is adapted to scan more often the plurality of wireless channels with recent roaming events instead of the plurality of wireless channels with less recent roaming events. Alternatively, the scanning pattern is adapted to one of scan more often the plurality of wireless channels with higher rates of change in wireless signal strength instead of the plurality of wireless channels with lower rates of change in wireless signal strength; or scan less often the plurality of wireless channels determined to be radar avoidance channels instead of the plurality of wireless channels not determined to be radar avoidance channels.

### BRIEF DESCRIPTION OF THE DRAWINGS

The present invention is illustrated and described herein with reference to the various drawings of exemplary embodiments, in which like reference numbers denote like method steps and/or system components, respectively, and in which:

FIG. 1 is an exemplary wireless network including a plurality of wireless access devices and a wireless switch;

FIG. 2 is a schematic representation of an exemplary embodiment of a wireless switch suitable for use in a network, such as the wireless network in FIG. 1;

FIG. 3 is a schematic representation of a mobile device suitable for use in a network, such as the wireless network in FIG. 1;

FIG. 4 is a flow chart of a roaming event collection process for tracking roaming events, such as in the wireless network in FIG. 1;

FIG. 5 is a flow chart of a station information transmission process for providing information to clients, stations, etc. about channel usage, such as in the wireless network in FIG. 1;

FIG. 6 is a flow chart of a station channel scanning process for optimizing wireless channel scanning, such as in the wireless network in FIG. 1;

FIG. 7 is two diagrams of rates of change in wireless signal strength between two access devices; and

FIG. 8 is a flow chart of a process for identifying a radar avoidance channel; and

FIG. 9 is a diagram of a frame format for transmitting channel information messages between wireless switches, controllers, access devices, and clients or STAs.

### DETAILED DESCRIPTION OF THE INVENTION

In various exemplary embodiments, the present invention optimizes WLAN channel scanning by collecting roaming data and passing summary information to wireless clients. The wireless clients are configured to utilize the summary information for WLAN channel scanning, roaming, etc. The present invention further includes a scanning algorithm associated with wireless clients that is weighted to scan more likely channels. Also, the present invention may weight the scanning algorithm to avoid radar avoidance channels, such as in IEEE 802.11h. Further, the scanning algorithm may be weighted to scan more often of channels with fast rates of change in wireless signal strength and the like. Advantageous, the present invention utilizes real data to optimize channel scanning at wireless clients thereby improving battery life and user experience while roaming.

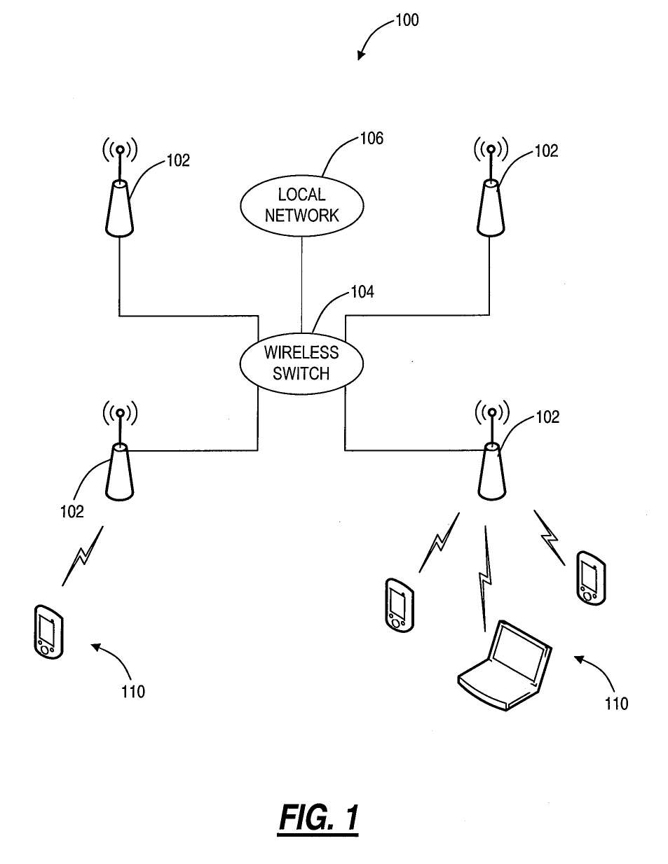

Referring to FIG. 1, in an exemplary embodiment, a wireless network 100 includes, without limitation, a plurality of wireless access devices 102 and a wireless switch 104. In an exemplary embodiment, the wireless network 100 is configured to support communications between and/or among mobile devices 110, and may include additional devices to support the functionality of the wireless network 100, such as Ethernet switches, and the like. In this exemplary embodiment, the wireless access devices 102 are access ports that cooperate with the wireless switch 104. In alternate exemplary embodiments, the wireless access devices 102 can be realized as access points (APs) that include embedded processing capabilities that take the place of that normally provided by the wireless switch 104. It should be appreciated that the wireless switch 104 may not be used in such alternate embodiments, and that the features and/or functionality described below in the context of the wireless switch 104 may be equivalently incorporated into the access devices 102 in such embodiments that do not include the wireless switch 104, i.e. fully functional access devices (e.g., access points) with embedded wireless switch functionality.

The wireless switch 104 may be coupled to a local network 106, which in turn may be coupled to one or more additional components and/or computer networks. It should be understood that FIG. 1 is a simplified representation of a wireless network 100 for purposes of explanation. A practical embodiment may have any number of wireless switches 104, each supporting any number of wireless access devices 102, and each wireless access device supporting any number of mobile devices 110. The topology and configuration of the wireless network 100 can vary to suit the needs of the particular application, and FIG. 1 is not intended to limit the application or scope of the subject matter in any way. In an exemplary embodiment, the wireless network 100 is configured as a wireless local area network (WLAN). In alternative exemplary embodiments, the wireless network 100 may be configured as a wireless personal area network (WPAN), a wireless wide area network (WWAN), or any other suitable network configuration. The wireless network 100 may be configured to utilize a data communication protocol in accordance with IEEE 802.11 WLAN protocols, IEEE 802.16 protocols, conventional Internet Protocol techniques, transmission control protocol/Internet protocol (TCP/IP), hypertext transfer protocol (HTTP), simple object access protocol (SOAP), or another comparable protocol. Additionally, the wireless network 100 may be configured to operate over a plurality of wireless channels within a certain frequency band. For example, the frequency band may include the 2.4 GHz, 5 GHz, etc. bands and the plurality of wireless channels may include channels defined in the various IEEE 802.11 protocols.

In an exemplary embodiment, the wireless access devices 102 are coupled to the wireless switch 104. Depending on the embodiment, the wireless access devices 102 may be coupled to the wireless switch 104 via one or more additional access devices, wireless switches, Ethernet switches, routers, and/or various combinations thereof. In an exemplary embodiment, the wireless access devices 102 are configured to receive data from mobile devices 110 over wireless data communication links. Once that data is captured by the wireless access device 102, the data may be encapsulated (e.g., into a packet format compliant with a suitable data communication protocol) for communication to another access device 102, a mobile device 110, and/or the local network 106. In an exemplary embodiment, the wireless access devices 102 are realized as wireless access points, which rely on the network intelligence and management functions provided by the wireless switch 104. It should be understood that in alternative embodiments, the wireless access devices 102 may include network intelligence and management functions incorporated therein.

A mobile device 110 may be realized using any suitable platform, including, without limitation: a cellular telephone; a smart phone; a personal digital assistant (PDA); a digital media player (e.g., mp3 player); a video game device; a laptop or other portable computer; or the like. In an exemplary embodiment, the mobile device 110 is configured to periodically scan for access devices 102, and maintain a list and/or table of the access devices 102 having a signal strength that indicates the mobile device 110 is within the communication range of the access device 102. For example, a mobile device 110 may receive broadcast messages and/or beacon signals from access devices 102 within communication range advertising their identity (e.g., service set identifier (SSID) or media access control (MAC) address). The mobile device 110 may then be configured to select an access device from the list of access devices within range, and send an association request to the selected access device. The mobile device 110 may automatically select the access device based on signal strength, in a random order, prompt a user for manually selecting an access device, or select an access device in some other manner. It should be appreciated that the functionality of the mobile device 110 will largely be dependent on the user, manufacturer, or vendor responsible for configuring and/or designing the mobile device, and the subject matter described herein is not limited to a specific manner of identifying an access device and making an association request.

In an exemplary embodiment, a mobile device 110 sends an association request, which may include information about the mobile device 110 (e.g., supported data rates) and the identity of the access device and/or network it wishes to associate with. In an exemplary embodiment, the access devices 102 are configured to route the association request to the wireless switch 104 for analyzing and responding to the association request. In general, the wireless switch 104 sends an association response containing an acceptance or rejection notice to the mobile device 110 requesting association via an access device 102. If the association is granted, the wireless switch 104 may also provide information regarding the association, such as supported data rates or association identification, as will be understood.

In various exemplary embodiments, the wireless switch 104 and/or access devices 102 are configured to collect roaming information related to the wireless network 100 and to pass a summary of this information on to various mobile devices 110. Advantageously, the collection and distribution of this information improves channel scanning of the mobile devices 110 optimizing both battery power usage, i.e. less channels to scan, and user experience, i.e. faster connection times. Through the systems and methods of the present invention, useless channel scans are reduced or eliminated, and scans which improve roaming are emphasized over scans that do not. Various benefits can be derived from the present invention. For example, since information is based on actual data, there may be no need to provision separate data elements as separate data elements may not reflect actual values. In addition, self learning may be enhanced as data reflects actual events as they occur, providing meaning.

In an exemplary embodiment, the present invention includes collecting roaming information on the wireless switch 104, e.g. a Wireless LAN Controller (WLC), and passing summary information to the mobile devices 110 through the access devices 102. Alternatively, the access devices 102 can collect the roaming information. The collection of the roaming information can include tracking each roaming event, such as, for example, where a device 110 associates from one access device 102 to another access device 102, recording tuples (e.g., AP1, Channel of AP2, timestamp), and deleting previous tuples matching (e.g., AP1, Channel of AP2, any timestamp). The present invention can also include transmitting summary information to the access devices 102 and/or the mobile devices 110. For example, in one exemplary embodiment, when a mobile device 110 requests information, a list of channels in use on the various access devices 102 is provided. For each of these listed channels, a use list of tuples with the access device 102 associated with the mobile device 110 as a first element is provided. The method can also, for each of these channels, list roam time from current access device 102 to an access device 102 on that channel, or default if never.

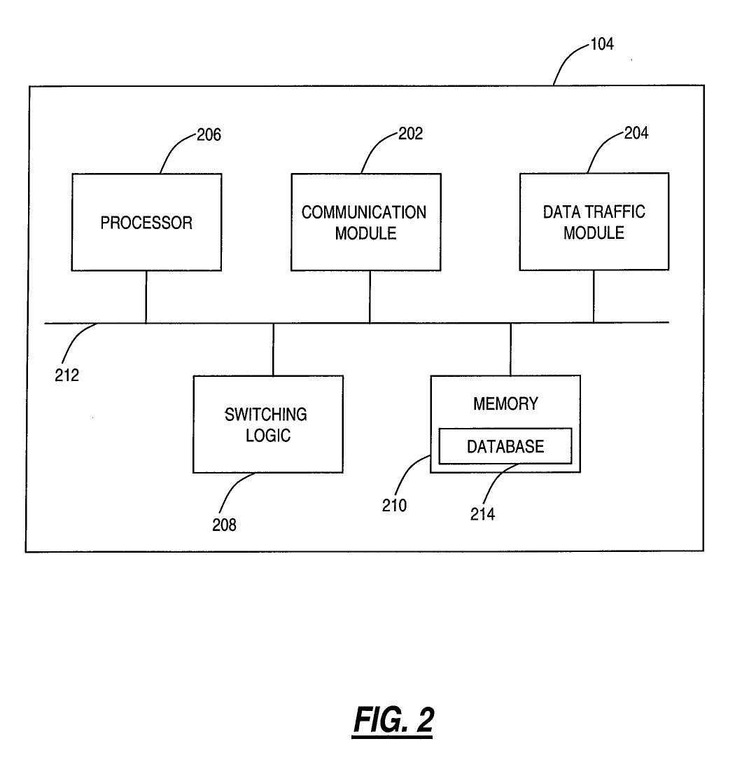

Referring to FIG. 2, in an exemplary embodiment, a schematic representation illustrates a wireless switch 104 suitable for use in a network, such as the wireless network 100 shown in FIG. 1. In an exemplary embodiment, the wireless switch 104 may include, without limitation: a communication module 202, a data traffic monitor 204, a processor 206, switching logic 208, and a suitable amount of memory 210. The elements of the wireless switch 104 may be interconnected together using a bus 212 or another suitable interconnection arrangement that facilitates communication between the various elements of the wireless switch 104. It should be appreciated that FIG. 2 depicts the wireless switch 104 in an oversimplified manner, and a practical embodiment may include additional components and suitably configured processing logic to support known or conventional operating features that are not described in detail herein. Alternatively, an access device 102 can include a similar architecture as illustrated herein in a configuration where the access device 102 is in a stand-alone configuration without the wireless switch 104.

In an exemplary embodiment, the wireless switch 104 contains intelligence and processing logic that facilitates centralized control and management of WLAN elements, including the wireless access devices (e.g., the wireless access devices 102 in FIG. 1) associated with the wireless switch 104. In an exemplary embodiment, one wireless switch 104 can support any number of wireless access devices (limited only by practical considerations). Thus, the wireless switch 104 can serve multiple wireless access devices, which in turn can serve multiple mobile devices. The wireless switch 104 is suitably configured to transmit and receive data, and it may serve as a point of interconnection between a WLAN and a fixed wire (e.g., Ethernet) network. In practice, the number of wireless switches 104 in a given network may vary depending on the number of network users and the physical size of the network. In another exemplary embodiment, the wireless switch 104 can include one or more wireless access devices 102 in the same device, e.g. this is typical of an AP configuration. Here, FIG. 2 may include a radio connected to the bus 212.

In an exemplary embodiment, the communication module 202 generally represents the hardware, software, firmware, processing logic, and/or other components of the wireless switch 104 that enable bi-directional communication between the wireless switch 104 and network components to which the wireless switch 104 is coupled. For example, referring to FIG. 1, the communication module 202 is suitably configured to communicate with components on the wireless network 100, such as the wireless access devices 102 and/or the local network 106. For example, the communication module 202 provides an Ethernet interface such that the wireless switch 104 can communicate with a conventional Ethernet-based computer network. In this regard, the communication module 202 may include a physical interface for connection to the computer network, and the communication module 202 (and/or the processor 206) may handle Ethernet addressing for data packets sent from the wireless switch 200. Note, in the AP configuration, the communication module 202 is not needed to communicate to the wireless access devices 102, but instead may include one or more wireless radios.

In an exemplary embodiment, the communication module 202 may support one or more wireless data communication protocols that are also supported by the wireless network infrastructure. Any number of suitable wireless data communication protocols, techniques, or methodologies may be supported by the communication module 202, including, without limitation: RF; IrDA (infrared); Bluetooth; ZigBee (and other variants of the IEEE 802.15 protocol); IEEE 802.11 WLAN (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the Wireless Medical Telemetry Service (WMTS) bands; General Packet Radio Service (GPRS); proprietary wireless data communication protocols such as variants of Wireless USB; and the like. In an exemplary embodiment, the communication module 202 is compliant with at least the IEEE 802.11 specification and configured to receive association requests via access devices coupled to the wireless switch 104, as described below. The communication module 202 may include or be realized as hardware, software, and/or firmware, as will be appreciated in the art.

The traffic monitor 204 is configured to monitor the flow or amount of data processed by the wireless switch 104. The data traffic monitor 204 may be implemented or performed with a processor 206, a content addressable memory, a digital signal processor (DSP), an application specific integrated circuit (ASIC), a field programmable gate array (FPGA), any suitable programmable logic device, discrete gate or transistor logic, discrete hardware components, or any combination thereof, designed to perform the functions described below. In an exemplary embodiment, the data traffic monitor 204 can monitor the throughput, data rate, data volume, packet count, an average data rate, an average data volume, or any quantity or characteristic based upon empirical or statistical information. The monitored data may be unidirectional or bidirectional, depending upon the specific application. In an exemplary embodiment, the data traffic monitor 204 is configured to monitor data and/or network traffic for the individual access devices. For example, the data traffic monitor 204 may implement a table (or list, cache, database or another suitable data structure) that maintains associations of the monitored data and/or statistics with the respective access device transmitting/receiving the data for those access devices associated with the wireless switch 104. As described in more detail below, the information obtained by data traffic monitor 204 can be utilized to collect and distribute roaming information about channels among wireless access devices in a wireless network.

The processor 206 may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this regard, a processor may be realized as a microprocessor, a controller, a microcontroller, a state machine, or the like. The processor 206 may also be implemented as a combination of computing devices, e.g., a combination of a digital signal processor and a microprocessor, a plurality of microprocessors, one or more microprocessors in conjunction with a digital signal processor core, or any other such configuration. In practice, the processor 206 includes processing logic that may be configured to carry out the functions, techniques, and processing tasks associated with the operation of the wireless switch 104, as described in greater detail below. Furthermore, the steps of a method or algorithm described in connection with the embodiments disclosed herein may be embodied directly in hardware, in firmware, in a software module executed by processor 206, or in any practical combination thereof.

The switching logic 208, which may be partially or completely realized in the processor 206, represents processing logic and functionality associated with the data switching and communicating features of the wireless switch 104. The switching logic 208 may be configured to perform conventional operations that enable data traffic in the wireless network to be communicated between mobile devices, access devices, network infrastructure components, and network-based systems or applications. In an exemplary embodiment, the switching logic 208 and the processor 206 may be cooperatively configured to implement processing logic and functionality associated with the handling of association requests that originate at mobile devices 110, as described in greater detail below.

The memory 210 includes sufficient data storage capacity to support the operation of the wireless switch 104. The memory 210 may be realized as RAM memory, flash memory, registers, a hard disk, a removable disk, or any other form of storage medium known in the art. In this regard, the memory 210 may be coupled to the processor 206 such that the processor 206 can read information from, and write information to, the memory 210. Alternatively, the memory 210 may be integral to processor 206. In accordance with one embodiment, one or more software modules may reside in memory 210. In an exemplary embodiment, memory 210 is utilized to store information associated with various wireless access devices or mobile devices associated with the wireless switch 200 in a database 214, as described in greater detail below.

In an exemplary embodiment, the wireless switch 104 can include a Motorola RFS7000 Wireless LAN Controller (WLC) that can control up to 256 access points. Here, utilizing the systems and methods of the present invention, the WLC may maintain status of every activity on those access points, including when a device associates with a new AP. The WLC can then generate a graph of APs and timings of the most recent roaming events between APs. The present invention utilizes communication of status between mobile devices 110, access devices 102, and wireless switches 104. In an exemplary embodiment, this communication can be through the Wireless Network Management Protocol (WNMP) from Motorola and Symbol Technologies. In other exemplary embodiments, the wireless switch 104 and/or access devices 102 can include a Motorola AP300, AP7131, and the like. Specifically, the present invention contemplates use with any wireless switch and/or wireless access point. Thus, the present invention can include the WNMP Channel Information Message to optimize scanning on WLAN channels, radar avoidance channels, etc. The WNMP Channel Information message is a request/response message, and the present invention can include modifications to this message to transmit actual channel usage information from controllers/switches to stations (STA)—wireless clients. Alternatively, the present invention can utilize communication through IEEE 802.11 in vendor-specific bytes or undefined overhead bytes.

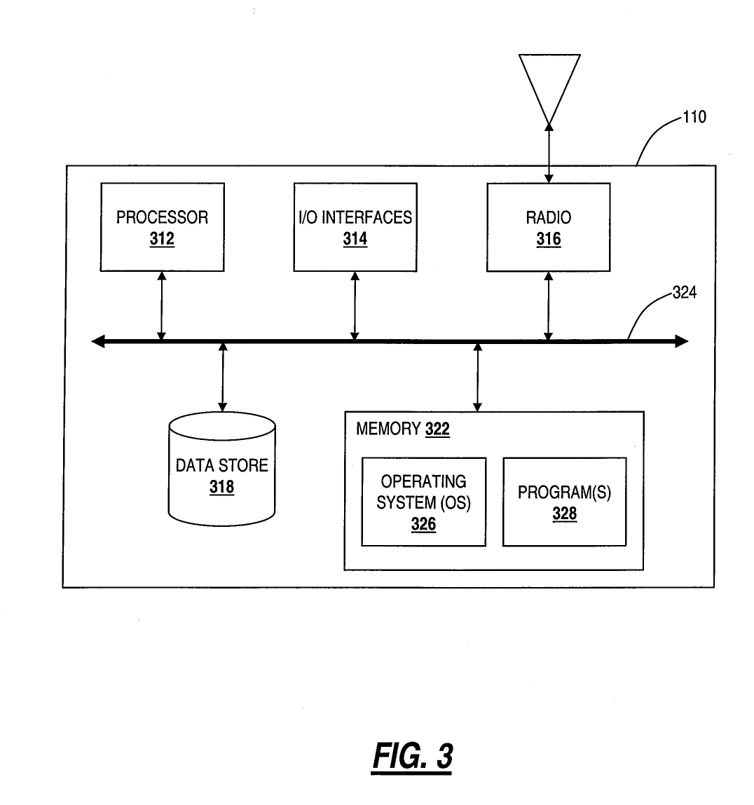

Referring to FIG. 3, in an exemplary embodiment, a schematic representation illustrates a mobile device 110 suitable for use in a network, such as the wireless network 100 shown in FIG. 1. The mobile device 110 can be a digital device that, in terms of hardware architecture, generally includes a processor 312, input/output (I/O) interfaces 314, a radio 316, a data store 318, and memory 322. It should be appreciated by those of ordinary skill in the art that FIG. 3 depicts the mobile device 110 in an oversimplified manner, and a practical embodiment may include additional components and suitably configured processing logic to support known or conventional operating features that are not described in detail herein. The components (312, 314, 316, 318, 320, and 322) are communicatively coupled via a local interface 324. The local interface 324 can be, for example but not limited to, one or more buses or other wired or wireless connections, as is known in the art. The local interface 324 can have additional elements, which are omitted for simplicity, such as controllers, buffers (caches), drivers, repeaters, and receivers, among many others, to enable communications. Further, the local interface 324 can include address, control, and/or data connections to enable appropriate communications among the aforementioned components In an exemplary embodiment, the mobile device 110 can include the Motorola EWP 1000 and 2000, the Motorola MC75, and the like.

The processor 312 is a hardware device for executing software instructions. The processor 12 can be any custom made or commercially available processor, a central processing unit (CPU), an auxiliary processor among several processors associated with the mobile device 110, a semiconductor-based microprocessor (in the form of a microchip or chip set), or generally any device for executing software instructions. When the mobile device 110 is in operation, the processor 312 is configured to execute software stored within the memory 322, to communicate data to and from the memory 322, and to generally control operations of the mobile device 110 pursuant to the software instructions. The I/O interfaces 314 can be used to receive user input from and/or for providing system output to one or more devices or components. User input can be provided via, for example, a keyboard, a keypad, a mouse, a scroll bar, buttons, bar code scanner, and the like. System output can be provided via a display device such as a liquid crystal display (LCD), touch screen, and the like. The I/O interfaces 314 can also include, for example, a serial port, a parallel port, a small computer system interface (SCSI), an infrared (IR) interface, a radio frequency (RF) interface, and/or a universal serial bus (USB) interface. The I/O interfaces 314 can include a graphical user interface (GUI) that enables a user to interact with the mobile device 110.

The radio 316 enables wireless communication to an external access device or network, such as the plurality of wireless access devices 102 and the wireless switch 104. Any number of suitable wireless data communication protocols, techniques, or methodologies can be supported by the radio 316, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB. The data store 318 can be used to store data. The data store 318 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 318 can incorporate electronic, magnetic, optical, and/or other types of storage media.

The memory 322 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof.

Moreover, the memory 322 may incorporate electronic, magnetic, optical, and/or other types of storage media. Note that the memory 322 can have a distributed architecture, where various components are situated remotely from one another, but can be accessed by the processor 312. The software in memory 322 can include one or more software programs, each of which includes an ordered listing of executable instructions for implementing logical functions. In the example of FIG. 3, the software in the memory system 322 includes a suitable operating system (O/S) 326 and programs 328. The operating system 326 essentially controls the execution of other computer programs, and provides scheduling, input-output control, file and data management, memory management, and communication control and related services. The operating system 326 can be any of LINUX (or another UNIX variant), Android (available from Google), Symbian OS, iPhone OS (available from Apple, Inc.), Palm OS, Blackberry OS, Windows XP, Windows Vista, Windows 7, Windows Server 2003 and 2008, Windows Mobile 6, 6.5, etc. (all Windows variants available from Microsoft), and the like.

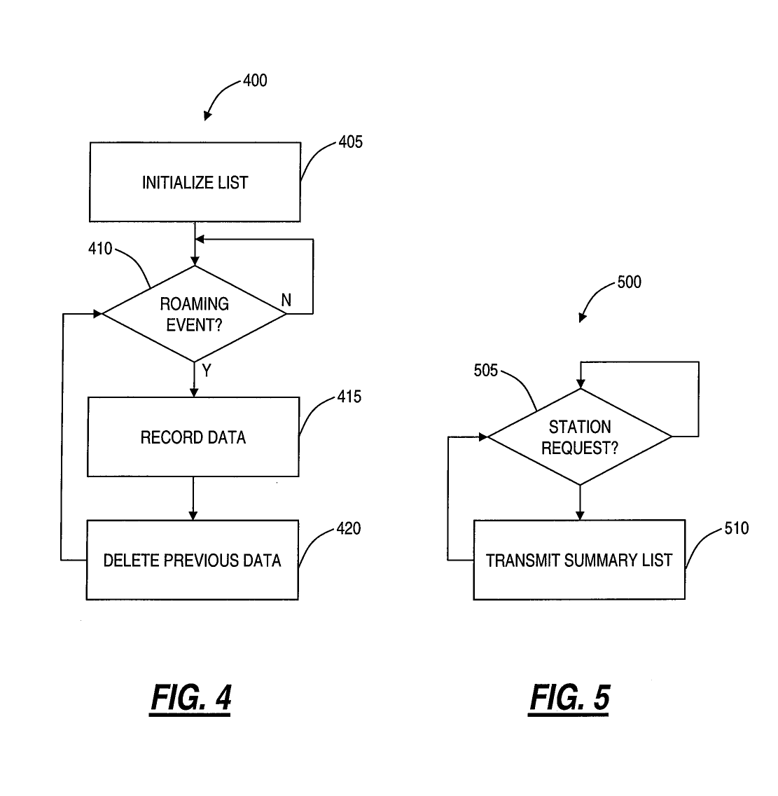

Referring to FIG. 4, in an exemplary embodiment, a flow chart illustrates a roaming event collection process 400 for tracking roaming events. The process 400 can be implemented by the wireless switch 104 and/or the access devices 102 in conjunction with the mobile devices 110. As described herein, the wireless switch 104 can operate with multiple access devices 102. Further, the wireless switch 104 is aware of all activity of the associated access devices 102, such as when a mobile device 110 associates with one of the access devices 102. The process 400 is an exemplary mechanism to construct a graph, list, database, etc. of access devices 102, mobile devices 110, and associated roaming events. In general, a roaming event includes a particular mobile device 110 connecting (e.g., associating) with a second access device 102 from a first access device 102, e.g. a STA (mobile device 110) disassociating with AP1 and associating with AP2. This may occur when the STA is out-of-range from AP1 and in-range of AP2, for example. The roaming event collection process 400 starts with initializing a list (step 405). The process 400 is a mechanism to collect data related to roaming events. This data may be stored in a list, graph, database, or any other format. In an exemplary embodiment, the list includes a plurality of tuples in the format of (APn, channel of APm, Timestamp) wherein APn is the access device roaming from, channel of APm is the channel that is roamed to, and timestamp represents the date, time, etc. of the event. This format may be utilized to track each time a mobile device associates from APn to APm.

The roaming event collection process 400 waits for a roaming event to occur (step 410). As described herein, the process 400 is implemented on a wireless switch or other device with visibility of events on a plurality of access devices. The wireless switch is notified of each roaming event so that layer two WLAN switching can be updated, e.g. a particular mobile device is now on APx from APy and adjust data traffic accordingly for that particular mobile device. Upon an occurrence of a roaming event, the process 400 records the data associated with the roaming event in the list (step 415). As described herein, a tuple can be recorded, such as (APx, channel of APy, Timestamp). Alternatively, any data can be recorded that can be useful in constructing a channel list for device scanning. Such data may include, access device identification, channel usage one each access device, amount of time on each access device, metrics such as received signal strength indication (RSSI) (e.g., rates of change in RSSI or Link Margin (LM)), and the like. Optionally, the roaming event collection process 400 may only keep one entry for each APn to APm roam, such as deleting any tuple matching (APx, channel of APy, any timestamp). Here, the process 400 is mainly concerned with current channel usage to enable improved channel scanning among clients. Thus, old data is out-of-date when a new roaming event occurs.

Referring to FIG. 5, in an exemplary embodiment, a flow chart illustrates a station information transmission process 500 for providing information to clients, stations, etc. about channel usage. The process 500 is utilized by the wireless switch or the like to provide channel usage information to clients in order to provide optimized channel scanning at the client. Specifically, the process 500 operates by receiving a request for information from a client (step 505). Based on this request, the process 500 transmits summary channel information to that client (step 510). The summary information may include a list of channels in use, such as on the wireless switch and the associated access devices. Further, the summary information may include, for each of the channels in use, a list of tuples with the particular client's current access device as the first element in each of the list of tuples. For example, assume client U is associated with APv, and client U requests summary information from the wireless switch. Here, the wireless switch may provide a list of all channels in use plus all the tuples with APv as the first element, e.g. all tuples including (APv, X, Y) where X is the channel of another AP roamed to from APv and Y is a timestamp. For the timestamp, a default value can be used if never roamed to.

In an exemplary embodiment, a typical graph entry of data by the wireless switch includes AP1->AP2 and associated with this graph entry is a time of the last roam. The wireless switch is configured to transmit this information to a station, client, device, etc. upon request. In one exemplary embodiment, a WNMP Channel information message is extended to include a field which shows the amount of time that has elapsed since a subscriber has roamed from this AP to the given channel. This field may be represented as int(log 2(time)) or it may be some other encapsulation. In an exemplary embodiment, an upper limit to the values is defined which is the default for all channels that do not have values under the limit. The AP is initiated and in the channel information message, to show all channels of APs connected to the WLC are included in the list, all channels are listed with the default value. In another exemplary embodiment, this information may be transmitted via bytes in an IEEE 802.11 message or some other mechanism.

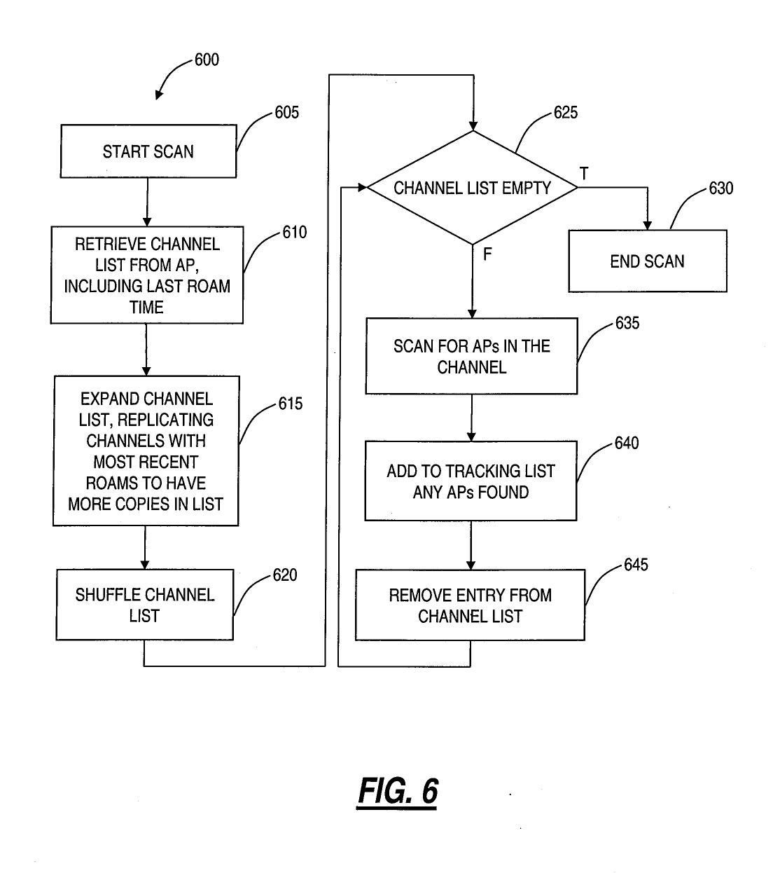

Referring to FIG. 6, in an exemplary embodiment, a flow chart illustrates a station channel scanning process 600 for optimizing wireless channel scanning. As described in FIGS. 4 and 5, a station (i.e., client, wireless device, mobile device, etc.) may receive channel information related to a current operating environment of a wireless network. The process 600 provides a mechanism for the station to prioritize channel scanning to the wireless channels that have the most recent values for roaming events. In an exemplary embodiment, on the station (STA), the STA prioritizes scanning based on the list of channels in the channel information message from the wireless switch. The STA does not scan channels that are not in the channel information element. In a start-up situation, e.g. start-up of a wireless switch, all channels may the same value, so STAs associated with an AP on that wireless switch in the start-up scenario scan all channels with equal priority. The STAs can discover the neighbors of the AP and track them as candidates for roaming. As roaming events occur, the information is updated and STAs receive updated information as soon as they request it from the AP.

The process 600 starts with a start scan process (step 605). The process 600 is implemented on a mobile device in communication with an access device and/or a wireless switch. For example, the mobile device may include the mobile device 110, such as illustrated in FIG. 3, and the process 600 may be implemented as one of the programs 328. First, a channel list data is retrieved including a last roam time (step 610). Here, this may include implementing the process 500 in FIG. 5. The process 600 may expand the channel list replicating channels with the most recent roams to have more copies of these channels in the list (step 615). Here, the process 600 may bias towards channels that are more recently roamed to, i.e. channels more likely to have activity and require scanning. The process 600 may shuffle the channel list (step 620). Here, the process 600 may randomize the list, placing the channels in a random, shuffled order. Note, the channels more likely to have activity are over represented due to the copying step. If the channel list is empty (step 625), the process 600 ends (step 630). If the channel list is not empty (step 625), the process 600 selects an entry from the list and scans for APs (access devices) in the channel from the entry (step 635). Any APs found are adding to a tracking list on the mobile device (step 640). The process 600 removes this channel entry from the channel list (step 645), and then returns to step 625. Note, the tracking list on the mobile device can be utilized by the mobile device for connecting and/or roaming in the network. This process 600 enables more efficient scanning of channels in that channels that have no APs on them are not scanned at all, which is a savings in both battery power and time. There is no need to listen for (up to) 100 ms on a channel that is not occupied by any APs.

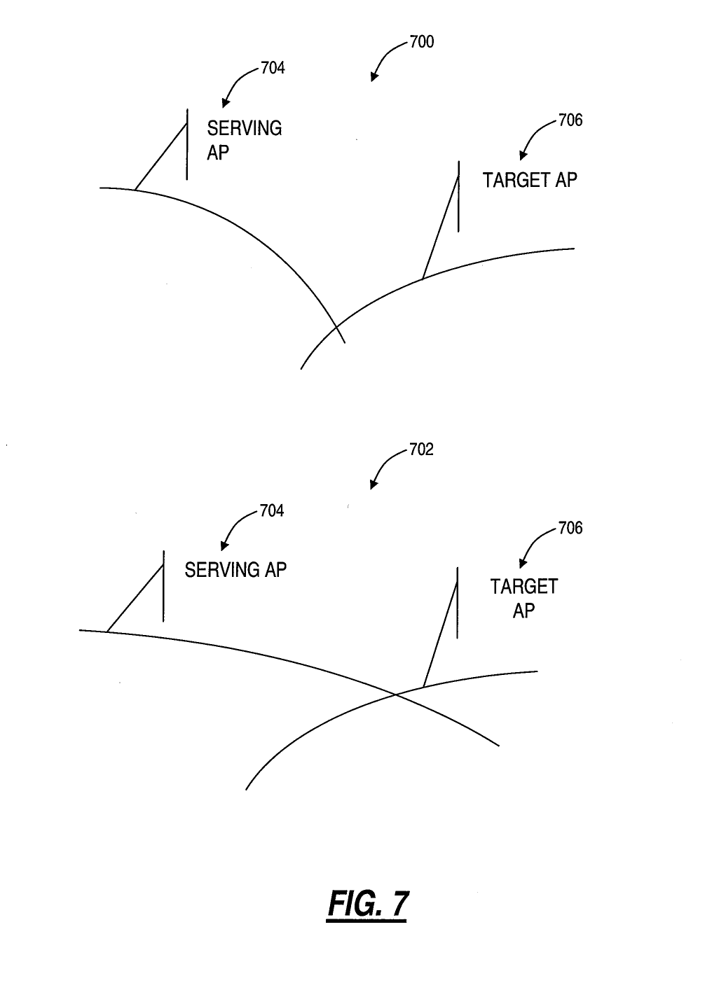

Referring to FIG. 7, in an exemplary embodiment, diagrams 700, 702 illustrate rates of change between two access devices 704, 706. The wireless signal strength may include received signal strength indication (RSSI) as a measurement of the power present in a received radio signal. This can be the RSSI measurements specified in the IEEE 802.11 protocols, i.e. RSSI measurements are unitless and in the range 0 to 255, expressible as a one-byte unsigned integer. Also, the wireless signal strength may include link margin, i.e. an amount of received power minus a minimum acceptable power. The serving AP 704 represents an AP that a client or STA is currently on, and the target AP 706 represents an AP that the client or STA is roaming to. In the diagram 700, the rate of change is high for the wireless signal strength, and thus the client or STA needs to be able to roam to the AP 706 quickly. Accordingly, more scans are needed on this channel. In the diagram 702, the rate of change is low for the wireless signal strength, and thus there is no need for more scans as fewer scans will still result in successful roam before loss of service.

In FIGS. 4 and 5, the process 400 may record wireless signal strength information, such as at step 415, and the process 500 may transmit this information to STAs, such as at step 410. In FIG. 6, this wireless signal strength information can be utilized to optimize and improve wireless channel scanning by a STA. First, in an exemplary embodiment, instead of using the last time that a STA roamed off of an AP for the weighting of the channel list in FIG. 6, the channel list is weighted by a quantile of the rates of change in the RSSI (or link margin) of a STA before it roamed to the next channel. Since RF paths are symmetric, the rate of change of the RS SI (or link margin) is indicative of the STA's connection to the AP. If a STA is aware that when it is going out of coverage on the current AP, if it is in danger of falling off the AP and roam to a certain channel, the STA scans that channel more often than other channels. If the device is not in danger of falling off of the AP's area of coverage when roaming to another AP, the STA scans that AP less often. For example, here, the process 600 can creates the channel list (steps 610-620) based on the rates of change in the RSSI (or link margin) of a STA before it roamed to the next channel.

In another exemplary embodiment, the rate of change of wireless signal strength is extended to specific APs instead of a channel in the channel list, so that during a tracking scan, the optimization is per-AP, not per-channel. This is implemented as an extension to the neighbor list that is included in the 802.11k standard. For example, in the process 600, the channels in the channel list are weighed by the worst quintile of rates of change in RSSI or Link Margin (LM) that resulted in a roam to an AP on that channel. If an AP has a steep fall-off in its area of coverage, and roams in that area go to channel N, then channel N is scanned more often to improve the user experience. The AP interprets this as a drop off in its recorded RSSI of the device. If an AP does not have a steep fall of in its area of coverage for all roams to channel M, then channel M is scanned less often. The channel list format is updated to include this information.

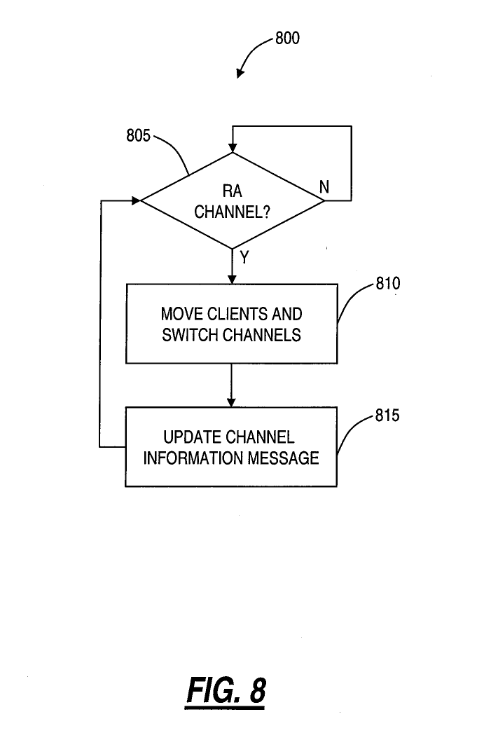

Referring to FIG. 8, in an exemplary embodiment, a flow chart illustrates a process 800 for identifying a radar avoidance channel. As described herein, APs or access devices are configured to detect radar avoidance (RA) channels, such as in IEEE 802.11h. The process 800 starts with the access device or AP looking for a RA channel (step 805). If the access device or AP detects a RA channel, then the access device or AP moves all of the associated clients to other channels and switches the channel (step 810). Note, the wireless switch or controller associated with the access device or AP will also be notified by the access device or AP that the RA channel has been detected. Accordingly, the wireless switch or controller can update channel information messages with such information (step 815). Here, the present invention can include information about the RA channel with the scope of the processes 400, 500, 600 in FIGS. 4-6. Advantageously, the present invention can be used to identify if IEEE 802.11h is in use, i.e. the wireless switch or controller will know IEEE 802.11h is in use at one or more AP or access device. The present invention may be used to remove or reduce frequency of occurrence of useless and expensive scans on IEEE 802.11h channels when channel is not in use. Furthermore, the present invention can be used to identify when a channel switch has occurred. This can include removing a channel from the above described channel list or increasing the last roam time to a default value.

In an exemplary embodiment, if the AP or access device is on a radar avoidance channel, the AP or access device performs the usual set of procedures to look for radar signals. If radar is detected, the AP or access device switches to another channel after moving all associated subscribers off of the channel via a channel switch announcement. As the wireless switch or controller is aware that this AP or access device has moved off the channel, the wireless switch or controller updates the channel information message. If there are other APs still on this channel but which have not detected radar, the channel remains on the channel information message, but the time since last roam is set to a default value, such that scans are limited in, for example, the process 600 of FIG. 6. If all APs that were on this channel detected radar, then the channel is removed from the channel information message, such that no future scans occur on this channel.

In an exemplary embodiment, if a STA receives the channel information message and the value is not the default value, but is a value that is less than the default value, the STA can infer two things about this channel. The first is that there is an AP on that channel within roaming distance of the current AP, and second, if the AP is on a radar avoidance channel, the AP was not subject to radar avoidance at the time that the channel information message request was sent to the AP and wireless switch. Advantageously, for IEEE 802.11h channels, the disclosed techniques are of particular importance because these channels require that the STA listen for an enabling signal before transmitting, instead of using probe request/probe response messages. In addition, by including an encoding of when a channel was last roamed to by a STA associated to the current AP, the STA can prioritize scanning to the most likely channels that result in successful roaming events. Furthermore, when a STA initiates a scan and retrieves the channel list, the STA is provided with immediate notification that a radar avoidance channel in its neighborhood has been vacated. In some embodiments that use the rate of change as weighting of channels, improved scanning of channels and improved user experience are achieved.

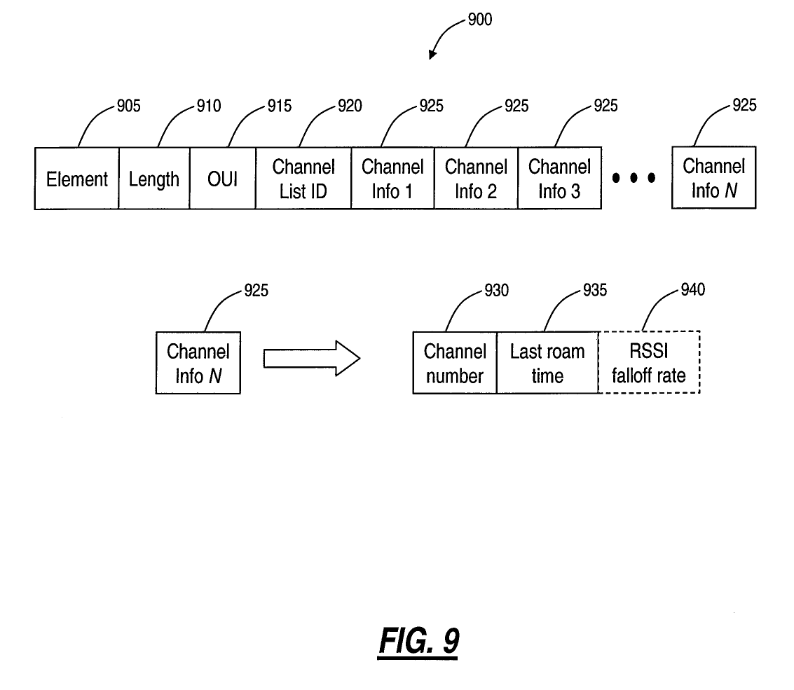

Referring to FIG. 9, in an exemplary embodiment, a diagram illustrates a frame format 900 for transmitting channel information messages between wireless switches, controllers, access devices, and clients or STAs. For example, the frame format 900 may be compliant to any of the IEEE 802.11 protocols and variants thereof. The frame format 900 may include various fields, such as: an element field 905 that may be set to 221 as an IEEE 802.11 identifier for vendor-specific messages, a length field 910 for a length of the frame format 900 in bytes, an organizationally unique identifier (OUI) 915 specific to the vendor, a channel list ID field 920 that is a constant which identifies this as a channel information message with a list of channel info elements (may have subfields based on a vendor's specific numbering plan), and a plurality of channel info messages 925 that each convey summary channel information related to roaming and that may be utilized to optimize a scanning pattern of a client or STA. Specifically, the frame format 900 may be utilized to transmit the summary information in the process 500 of FIG. 5. Each of the plurality of channel info messages 925 may include sub-fields such as a channel number 930, a last roam time 935, and optionally a RSSI fallout rate 940. For example, the frame format 900 may be used to transmit the channel list and associated tuples from the wireless controller or switch to a client upon request. Further, the client may utilize this information in the frame format 900 to adapt a scanning pattern, such as described in the process 600 of FIG. 6.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A wireless network, comprising:
an access device; and
one or more clients each communicatively coupled to the access device;
wherein the access device is configured to transmit roaming event data associated with each roaming event for the one or more clients.

2. The wireless network of claim 1, further comprising:
a wireless switch; and
a plurality of access devices each communicatively coupled to the wireless switch.

3. The wireless network of claim 2, wherein the one or more clients are configured to periodically scan wireless channels to detect any of the plurality of access devices on the wireless channels.

4. The wireless network of claim 3, wherein the one or more clients are configured to request channel information from one of the wireless switch or the plurality of access devices, and wherein the one or more clients are configured to adapt a scanning pattern based on the channel information.

5. The wireless network of claim 4, wherein the scanning pattern is adapted to scan more often the wireless channels with recent roaming events instead of the wireless channels with less recent roaming events.

6. The wireless network of claim 4, wherein the scanning pattern is adapted to scan more often the wireless channels with higher rates of change in wireless signal strength instead of the wireless channels with lower rates of change in wireless signal strength.

7. The wireless network of claim 4, wherein the scanning pattern is adapted to scan less often the wireless channels determined to be radar avoidance channels instead of the wireless channels not determined to be radar avoidance channels.

8. The wireless network of claim 2, wherein each roaming event is stored as a tuple of information comprising (identification of one of the plurality of access devices roamed from, a channel of another one of the plurality of access devices roamed from, a timestamp of the roaming event).

9. The wireless network of claim 8, wherein the one or more clients are configured to periodically scan wireless channels to detect any of the plurality of access devices on the wireless channels, wherein the one or more clients are configured to request channel information from one of the wireless switch or the plurality of access devices, wherein the channel information comprising a plurality of tuples with each of the identification of one of the plurality of access devices roamed from element comprising a current access device that the one or more clients is connected to, and wherein the one or more clients are configured to adapt a scanning pattern based on the plurality of tuples.

10. The wireless network of claim 9, wherein the tuple further comprises an identification of wireless signal strength, and wherein the scanning pattern is adapted to scan channels with high rates of change of the wireless signal strength relative to channels with low rates of change of the wireless signal strength.

11. The wireless network of claim 9, wherein the channel information is transmitted to the one or more clients by one of the wireless switch or the plurality of access devices through an IEEE 802.11 vendor specific frame format.

12. The wireless network of claim 2, wherein one of the plurality of access devices operates according to IEEE 802.11h, wherein the one of the plurality of access devices is configured to detect radar avoidance channels amongst the wireless channels, and the one or more clients are configured to adapt a scanning pattern based on the detection of radar avoidance channels thereby eliminating or reducing unnecessary IEEE 802.11h channel scanning.

13. A method of scanning channels in a wireless network, comprising:
at one of a switch or an access device, monitoring for roaming events associated with a plurality of access devices communicatively coupled to one or more clients;
recording data associated with each of the roaming events; and
responsive to a request from a client, summarizing the recorded data and transmitting the summarized recorded data to the client.

14. The method of claim 13, further comprising:
at the client, receiving the summarized recorded data; and
adapting a scanning pattern of a plurality of wireless channels in the wireless network based on the summarized recorded data.

15. The method of claim 14, wherein the scanning pattern is adapted to scan more often the plurality of wireless channels with recent roaming events instead of the plurality of wireless channels with less recent roaming events.

16. The method of claim 13, wherein the scanning pattern is adapted to scan more often the plurality of wireless channels with higher rates of change in wireless signal strength instead of the plurality of wireless channels with lower rates of change in wireless signal strength.

17. The method of claim 13, wherein the scanning pattern is adapted to scan less often the plurality of wireless channels determined to be radar avoidance channels instead of the plurality of wireless channels not determined to be radar avoidance channels.

18. A wireless client, comprising:
a radio, memory, and a processor, wherein each of the radio, the memory, and the processor are communicatively coupled to one another;
wherein the radio, the memory, and the processor are configured to:
periodically scan a plurality of wireless channels in a wireless network;
request channel information from one of an access point or a wireless switch; and
adapt a scanning pattern of the plurality wireless channels based on the channel information.

19. The wireless client of claim 17, wherein the scanning pattern is adapted to scan more often the plurality of wireless channels with recent roaming events instead of the plurality of wireless channels with less recent roaming events.

20. The wireless client of claim 17, wherein the scanning pattern is adapted to one of
scan more often the plurality of wireless channels with higher rates of change in wireless signal strength instead of the plurality of wireless channels with lower rates of change in wireless signal strength; or
scan less often the plurality of wireless channels determined to be radar avoidance channels instead of the plurality of wireless channels not determined to be radar avoidance channels.
